(19) United States
(12) Patent Application Publication
(10) Pub. No.: US 2014/0352127 A1
(43) Pub. Date: Dec. 4, 2014

(54) Removable Lid for Brewing Cup

(71) Applicant: Louis Dakis, Clifton, NJ (US)

(72) Inventor: Louis Dakis, Clifton, NJ (US)

(21) Appl. No.: 13/909,480

(22) Filed: Jun. 4, 2013

(51) Int. Cl. A47J 31/44

(52) U.S. Cl. CPC A47J 31/4407
USPC 29/428; 99/323

(57) ABSTRACT

In an embodiment of the disclosed technology, a lid is used on a refillable and/or reusable brewing cup for brewing coffee or other (hot) drinks in a single or multi-cup brewing machine. Such a brewing cup allows one to add any coffee of one's choice, yet to use all the features of an automated single-cup brewing machine. The lid may be generally circular; having a circular top and circular bottom. The lid may have a central portal adapted for passage there-through of liquid. The lid may further have a partially-circumferential lip adapted to abut a corresponding partially-circumferential portion of a lip of the cup. The lid may be caused to slide over, and/or be removed from, the fillable portion of the cup.

### CROSS-REFERENCE TO RELATED APPLICATIONS

This application hereby expressly incorporates by reference to U.S. patent application Ser. No. 13/572,831 to Dakis filed Aug. 13, 2012. This application is also related to co-pending U.S. patent application to Dakis titled “Apparatus and Method for Refilling a Brewing Cup” filed Jun. 4, 2013, the contents of which are hereby incorporated by reference.

### FIELD OF THE DISCLOSED TECHNOLOGY

The disclosed technology relates generally to food and beverage apparatuses and, more specifically, to a removable lid for a brewing cup for single cup brewing.

### BACKGROUND OF THE DISCLOSED TECHNOLOGY

Automatic brewing machines for single cups of coffee or tea are known in the art. For example, U.S. Pat. No. 6,658,989, assigned to Keurig, Incorporated, discloses a single serving beverage brewer in which a measured charge of dry beverage medium is infused with a metered amount of heated liquid. This content of the '989 patent is herein incorporated by reference, in its entirety. A reusable beverage filter cartridge, with a cup-shaped housing having a top opening and bottom outlet port, an internal filter, and a removable lid, is used.

The drawback to such machines is that one typically must buy relatively expensive pre-packaged cups, each cup wrapped in a container to be disposed of, creating a lot of waste. While this is more convenient than brewing an entire pot of coffee for just one drink, and produces a much better-tasting drink than instant coffee which is added to hot water, a user typically cannot choose his/her preferred quantity of ground coffee, or add any coffee grounds of his/her choice. If one did so with an automatic single cup brewing machine, the results would be unreliable.

The filling of a reusable brew cup may also prove to be tedious due to the very nature of pouring coffee grinds into a small cup with a one- or two-inch diameter. While devices may exist to assist in refilling, or to automatically refill, brewing cups, the cups may still have to be sealed manually by a user after the grinds have been inserted. This may result in hygienic issues when the cups are used in a public setting, such as in an office. Moreover, the lid must be carefully applied in a manner such that the hole in the lid is aligned with the inlet of the single-cup brewing machine in order to properly utilize the machine.

Therefore, there is a need in the art to provide the convenience of single-cup coffee brewing machines, but with less waste, and with the low cost and flexibility of traditional multi-cup coffee makers.

### SUMMARY OF THE DISCLOSED TECHNOLOGY

Therefore, it is an object of the disclosed technology to find an efficient and easy way to use ground coffee and other particulate solids with a single-cup brewing machine, without spilling the solids or improperly applying the lid to the reusable cup.

As such, in an embodiment of the disclosed technology, a lid is used for application to a brewing cup (herein “cup,” “brew cup,” and/or “brewing cup”). Such a device allows one to add any coffee, while availing oneself of all the features of an automated single-cup brewing machine.

The lid may have a generally circular body (having a circular top and circular bottom) where “generally,” for purposes of this disclosure, is defined as “what an ordinary observer would consider as such” or “at least 75% being as such.” Thus, when the bottom of the lid is called “generally circular,” even though it may have a lip around the edge, it is still considered to be “generally circular,” and even though the top may have ridges, it is still considered “generally circular.” The lid may further have a portal at a midpoint of the circular shape. Moreover, the lid may be “generally flat,” such that the length and width of the lid are at least three times the height of the lid.

The lid may have a central portal adapted for passage there-through of liquid. The lid may further have a partially-circumferential lip adapted to abut a corresponding partial-circumferential portion of a lip of the cup. The lip of the lid may form a slot along a geometric arc of an interior of the circumference of the circular body of the lid. The lid may be caused to slide over and/or be removed from the fillable portion of the cup.

The cup has sides with circular cross-sections between a top side and bottom side, defining an inner cavity there-between. The cup has a lip at its top side, extending outwards from a respective inner cavity thereof, and a portal at/near the bottom side. This allows water to enter and flow through the cup before exiting the multi-chamber cup, such that the liquid becomes homogenized with dissolved particulate solid matter to produce a flavorful, high-quality drink.

The lip of the cup, in an embodiment, has a stepped bifurcation between an inner portion of the lip closer to the cavity of the cup, and an outer portion of the lip further from the cavity of the cup. That is, the lip is in two parts with a lower inner part and raised outer part, to accommodate the lid.

The lip of the cup may have two portions: a) a first portion being wider and/or extending further down towards a bottom side of the cup than a b) second portion. The lid may have a partial-circumferential lower lip, which may further correspond to the second portion of the lip of the cup, “correspond” being defined as covering opposite portions of an edge of the same imaginary circle. Thus, the lip of the lid and first portion of the lip, or entire lip, of the outer cup may be joined together to form a complete circumferential lip.

In an embodiment of the disclosed technology, a lid is provided for a brewing cup. The lid has a generally flat, circular body. The body has a lip extending partially around an outer circumference at a first geometric arc thereof, such that the circular body is bare around a remaining geometric arc. An “arc,” for purposes of this disclosure, is defined as a segment of the circumference of a circle. The lip is disposed on a side of the body and is adapted to engage the brewing cup. A slot is formed between a bottom of the lip and a corresponding bottom side of the circular body. A portal is disposed through the body perpendicular to the outer circumference thereof. The brewing cup has a flange around a circular opening. The flange has a geometric arc corresponding to the remaining geometric arc of the lid. The flange of the brewing cup corresponds to the slot of the lid.

In embodiments, the geometric arc of the flange is equal to the remaining geometric arc of the lid. In a method of applying the lid to the cup, the flange of the cup is inserted into the slot of the lid. In a further embodiment of the method, the lid is restricted to sliding along a single axis during application to the cup. That is, the lid has freedom of movement in two directions, along a single line.

In further embodiments of the disclosed technology, the lip of the lid and a lip of the cup form a continuous lip that circuitously runs along a circumference of the cup and the lid. That is, when placed on the cup, the lid and the cup give the appearance of a single, unified structure with a lip extending a full 360 degrees around the outer circumference thereof. In further embodiments, the inside of the slot of the lid is abutted on three sides by three corresponding sides of the flange of the cup. The lip of the body may have a groove disposed there-through for removing the lid from the brewing cup. The body may also have a depression around the portal. The depression extends outward from a midpoint of an outer extent of a circular cross-section of the body. The top surface of the body of the lid may have ridges to aid in removal and/or reapplication of the lid. The lip may only extend around less than 51% of the outer circumference of the body because, otherwise, the lid would be prevented from properly sliding atop the cup.

In another embodiment of the disclosed technology, a cup of a combination cup and lid has an opening disposed for attachment of the lid. The cup also has a bifurcated lip wherein substantially half of the bifurcated lip is wider than substantially another half of the bifurcated lip. The bifurcated lip inversely corresponds to bifurcated portions of a lip of the lid. The lid is attachable to, and retainable on, the cup, such that the lid covers the cup in a closed position. The lid moves perpendicularly to a plane of the opening of the cup, such that the bifurcated portions of said lip of the lid align and merge with the bifurcations in the lip of the cup.

In further embodiments of the combination cup and lid, the bifurcated portions of the lip of the lid and the bifurcated lip of the cup, when aligned and merged, give an appearance of a single, continuous lip that circuitously runs along a circumference of the combination cup and lid. The lid may have a dovetail groove for removal and/or reapplication of the lid to the cup. The lid may be restricted to sliding along a single axis when being applied to and/or removed from the cup.

In a method of using a lid on a brewing cup, the lid has a bifurcated lip extending partially around a circumference thereof. The brewing cup has a bifurcated lip of equal but inverse proportions to the bifurcated lip of the lid. The method is carried out, not necessarily in this order, by a) sliding the lid onto the brewing cup, wherein the sliding comprises moving the lid perpendicularly to the plane of an opening of the brewing cup, b) aligning and merging the bifurcated lip of the lid with the bifurcated lip of the brewing cup, such that the bifurcated lips collectively form a single, continuous lip circumferentially disposed about the opening of the brewing cup, and/or c) removing the lid from the brewing cup by sliding the lid away from the brewing cup in a direction perpendicular to the plane of an opening of the brewing cup.

In further embodiments of the method, the steps may be carried out by an automated brew cup refilling apparatus. The lid may also be removed by a thumb of a user. Sliding of the lid may be restricted to a single axis. In still further embodiments, a flange of the cup is mated to a slot of the lid.

It should be understood that the use of “and/or” is defined inclusively such that the term “a and/or b” should be read to include the sets: “a and b,” “a or b,” “a,” “b.”

Further features of the device, described above, are also applicable to a method of use.

### BRIEF DESCRIPTION OF THE DRAWINGS

FIG. 1 shows a top perspective view of a lid of an embodiment of the disclosed technology.

FIG. 2 shows a bottom perspective view of a lid of an embodiment of the disclosed technology.

FIG. 3 shows a blown apart view of a lid and a brewing cup of an embodiment of the disclosed technology.

FIG. 4 shows a perspective view of the fully assembled lid and brewing cup of an embodiment of the disclosed technology.

FIG. 5 shows a top plan view of the lid of FIGS. 1 and 2.

FIG. 6 shows a front elevation view of the lid of FIGS. 1 and 2.

FIG. 7 shows a rear elevation view of the lid of FIGS. 1 and 2.

FIG. 8 shows a side elevation view of the lid of FIGS. 1 and 2.

FIG. 9 shows a bottom plan view of the lid of FIGS. 1 and 2.

FIG. 10 shows a side schematic view of a combination lid and cup used in an automated brew cup refilling apparatus in an open position, according to embodiments of the disclosed technology.

FIG. 11 shows the automated brew cup refilling apparatus of FIG. 10 in a closed/neutral position.

FIG. 12 shows the automated brew cup refilling apparatus of FIG. 10 in a dispensing position.

### DETAILED DESCRIPTION OF EMBODIMENTS OF THE DISCLOSED TECHNOLOGY

In an embodiment of the disclosed technology, a lid is used on a refillable and/or reusable brewing cup (hereinafter interchangeably referred to as “cup,” “brew cup” or “brewing cup”) for brewing coffee or other (hot) drinks in a single or multi-cup brewing machine. Such a brewing cup allows one to add any coffee of one's choice, while using all the features of an automated single-cup brewing machine. The lid may be generally circular (having a circular top and circular bottom) where “generally,” for purposes of this disclosure, is defined as “what an ordinary observer would consider as such” or “at least 75% being as such.” Thus, when the bottom of the lid is called “generally circular,” even though it may have a lip around the edge, it is still considered to be “generally circular,” and even though the top may have ridges, it is still considered “generally circular.” The lid may further have a portal at a midpoint of the circular shape. Moreover, the lid may be “generally flat,” such that the length and width of the lid are at least three times the height of the lid.

The lid may have a central portal adapted for passage there-through of liquid. The lid may further have a partially-circumferential lip adapted to abut a corresponding partial-circumferential portion of a lip of the cup. In a sealed condition, the lid covers the cup such that the lips of the cup and lid form a complete circular lip. The lid may be caused to slide over and/or be removed from the fillable portion of the cup.

Embodiments of the disclosed technology will become clearer in view of the following detailed description of the drawings.

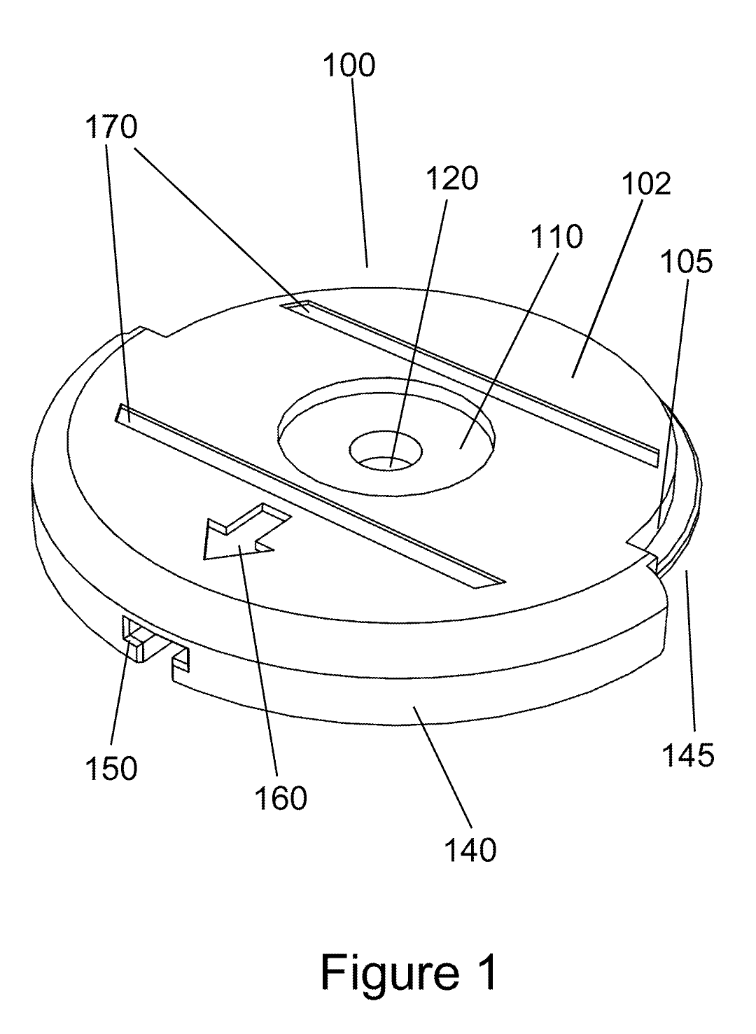

FIG. 1 shows a top perspective view of a lid of an embodiment of the disclosed technology. The lid 100, as described partially above, has a top surface 102 which may have ridges 170, as shown, to aid in gripping by a user, a tool and/or an apparatus adapted for grasping this lid. The ridges 170 may be arranged in varying configurations depending on the application with which the lid and/or brewing cup are to be used. The ridges 170 may be used by a tool and/or apparatus for removing and/or reapplying the lid 100 to a cup.

The lid has a depression 110 around a portal 120. The depression 110, in embodiments of the disclosed technology, extends outward from the midpoint to the outer extent of a circular cross section of the lid 100, with the depression beginning at the outer extent (side furthest away from the midpoint) of the portal towards the outer extent of the circular cross section of the lid. The depression 110 allows for alignment of a liquid expelling head of another device, with nozzle lined up with the portal 120. A lip 140 extends partially around the circumference of the lid 100, leaving a void 145 created in an imaginary space where the lip would extend if its circumferential path continued around the lower side of the body 150 of the lid, the body being defined as the portion above the plane of the flange of the lip. In the embodiment shown, the lip 140 extends 50% of the way around the circular circumference of the lid 100. In other embodiments, the lip 140 may extend 25%, 30%, 35%, or 45% all around, with a corresponding opposite lip of the cup collectively accounting for the rest of the circumference, to complete a lip around the entire circumference of the two abutted devices, the lid 100 and the cup.

The lid 100 also has an indicator arrow 160 for indicating to a user the direction that the lid should be removed or slid from the brewing cup. The lid 100 may further have a dovetail groove 150 to aid in removing and/or re-applying the lid to the brewing cup. The dovetail groove 150 is adapted to receive an end segment of a lid removal tool (not shown). Such a lid removal tool may be operated manually by a user, and/or may be incorporated into an apparatus that partially or completely automates the lid removal and/or cup-filling process.

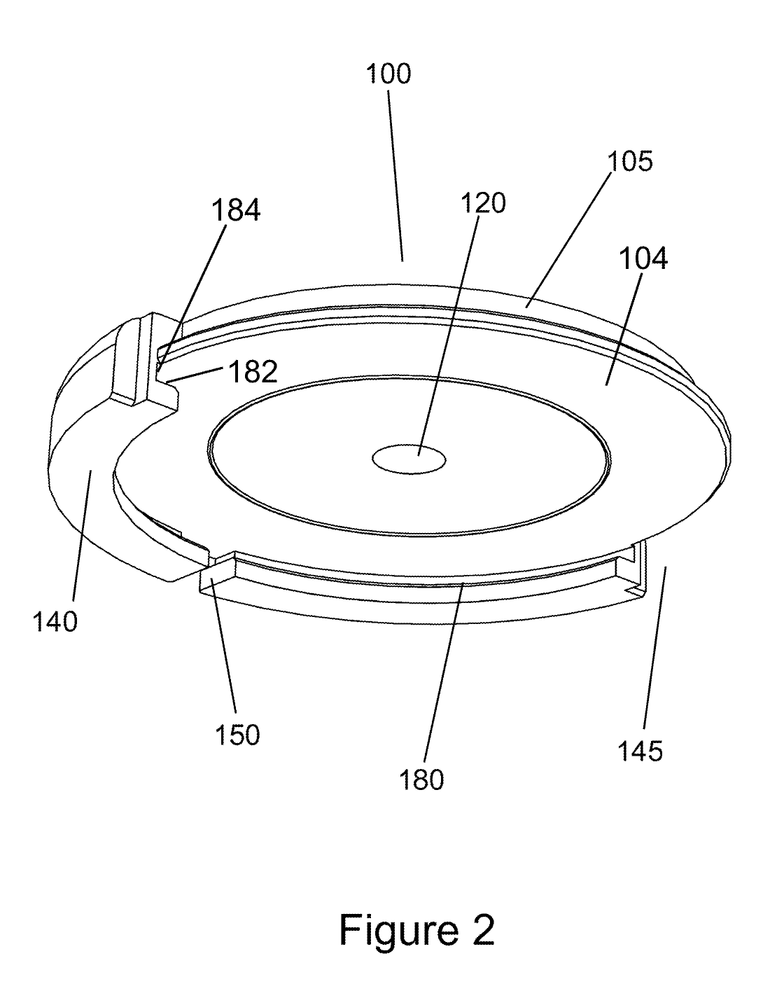

FIG. 2 shows a bottom perspective view of a lid of an embodiment of the disclosed technology. Here, one can see the lip 140 extending circumferentially and partially around the lower side of the body 105 of the lid 100, where the portal 120 encompasses a midpoint of the circular region, with the lip 140 forming a partial-circumference around an imaginary line passing directly through the center of the portal. The void 145 forms the opposing partial-circumference about the lower side of the body 105 of the lid 100.

A slot 180 is formed around the interior partial-circumference of the lip 140. The slot 180 is adapted to receive a flange portion of the brewing cup. The lid 100 is configured such that the flange of the brewing cup is received by the slot 180 only if the lid is applied in a sliding motion across the opening of the brewing cup in a particular direction. Thus, the user will know, with certainty, that the lid 100 has been properly applied to the brewing cup. The slot 180 runs along an interior geometric arc of the lid. The slot 180 has a generally rectangular cross-section. One of the four sides of the rectangular cross-section of the slot 180 is open. A bottom side 182, an interior side wall 184, and the bottom surface 104 of the lid 100 form the other three sides of the rectangular cross-section.

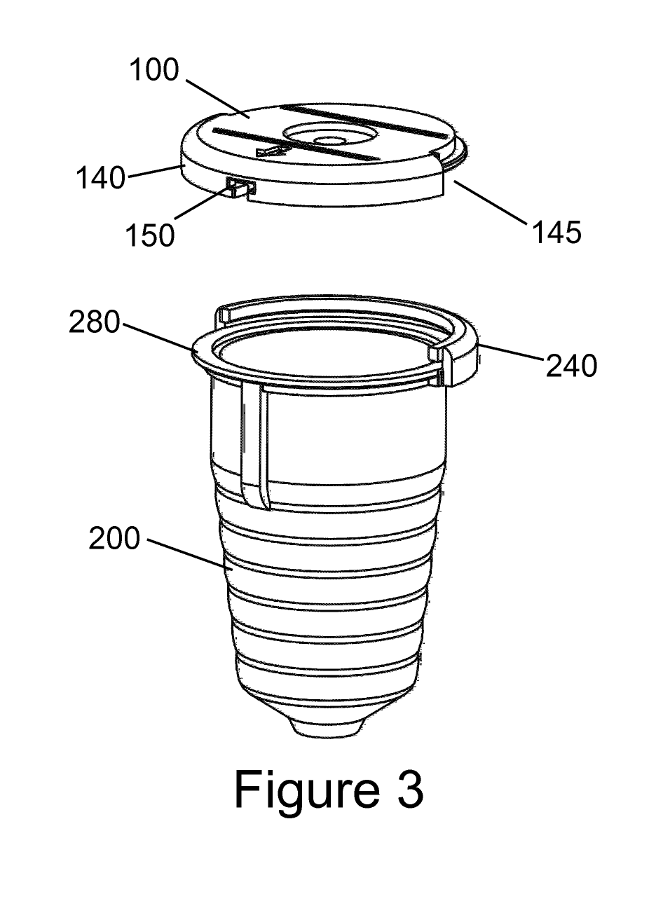

FIG. 3 shows a blown apart view of a lid and a brewing cup of an embodiment of the disclosed technology. The lid 100 is slidable over a top, exterior portion of the brewing cup 200. As previously described, a half-lip 140, extending 180 degrees or less than fully around the top opening of the lid 100 is adapted to be engaged with the corresponding half lip 240 or less than full lip of cup 200. In this manner, the lid 100 is slidable on and off, allowing for automating the covering and/or uncovering when used with a brewing machine or adapter for a brewing machine. A flange 280 about the partial-circumference opposing the half lip 240 is adapted to engage the slot 180 of the lid 100 as shown in FIG. 2. When the lid is engaged with the cup, the flange 280 abuts the three sides 182, 184, 104 of the rectangular cross-section of the slot 180.

The lip 140 extends partially around an outer circumference of the lid 100 at a first geometric arc. The remaining geometric arc of the lid 100 is bare. That is, the remaining geometric arc has a void where the lip 140 would extend if the lip were to extend around the entire circumference of the lid 100. Together, the first geometric arc and the remaining geometric arc combine to equal 360 degrees (i.e., a full circle). The flange 280 of the cup 200 likewise extends around the outer circumference at a geometric arc. In embodiments of the disclosed technology, the geometric arc of the flange 280 is equal to the geometric arc of the slot 180. Thus, the flange 280 fits into the slot 180, such that the flange 280 abuts the bottom side 182, the interior side wall 184, and the bottom surface 104 of the lid 100.

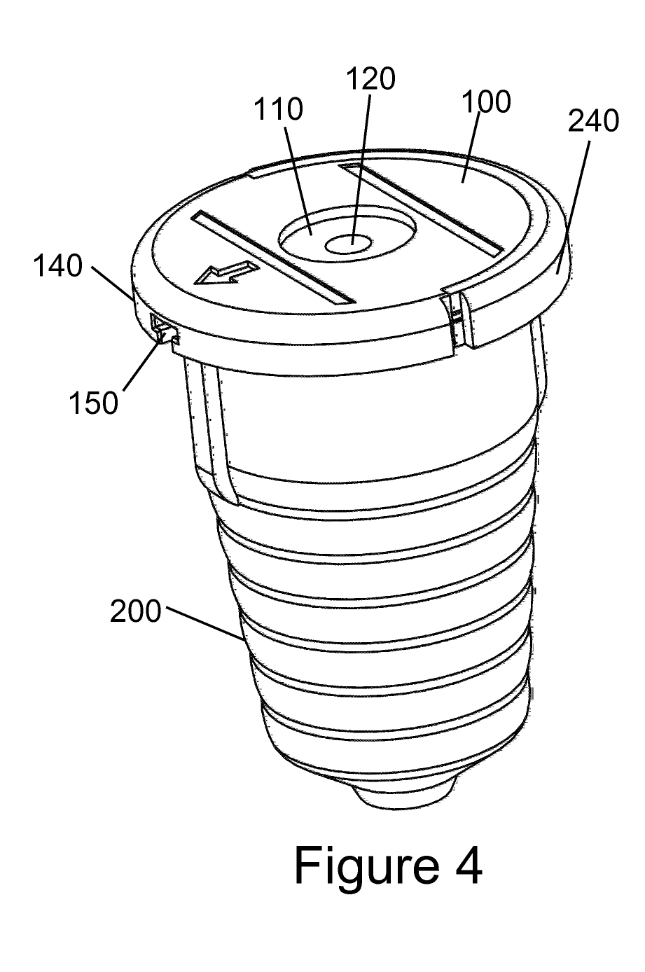

FIG. 4 shows a perspective view of the fully assembled lid and brewing cup of an embodiment of the disclosed technology. When fully assembled, a particulate solid matter rests in the interior of cup 200. Lip 140 and lip 240, which form a unitary structure with lid 100 and cup 200, respectively, abut each other in a manner such that two end points of each lip abut each other when the brewing cup is fully assembled, as shown. The reverse side is the same as the side shown. The abutting portions of the lips are the narrow, flat regions between the curved sides of each lip. The lid 100 is slid horizontally (across the plane of the top of and) onto the cup 200 until lip 140 abuts lip 240. The flange 280 of the cup 200 also engages the slot 180 of the lid 100 when the lid is slid into place.

In embodiments of the disclosed technology, the lip 140 of the lid 100 may interlock with the top of the cup 200, such that it is removable only by way of sliding it horizontally, with respect to the top of the respective cup. For purposes of this disclosure, “bottom” refers to the bottom side of the lid 100 and/or the cup 200, the bottom being in the direction of the pull of gravity. The “top” refers to the side where fluid is added, opposite the direction of gravity. “Lower side of the cup” or “lower portion of the cup” refers to the side of a cup 200, closest to the bottom and no more than starting 25% of the distance from the bottom. “Upper side” (or “upper portion”) is the opposite of lower side, in that it refers to the side of a cup 200, closest to the top and no more than starting 25% of the distance from the top. The “front” of the lid 100 is the portion of the lid having the dovetail groove 150. The “rear” of the lid 100 is the portion which is defined by the void 145 partially encompassing about 50% of the circumference of the lid.

Referring still to FIG. 4, the brewing cup is in a fully assembled condition. The lid 100 is placed atop the cup 200, which may be filled with particulate solid matter. Liquid enters through the upper portal 120 of the lid 100, into the cavity of the cup 200. Coffee grounds, tea, and/or another particulate solid material, leaf, or flavor-adding compound dissolve in, or partially exit from, the base of the cup 200 with the liquid.

While it will become clearer in view of the foregoing figures, in use, one removes the lid 100 from the cup 200 by sliding the lid perpendicularly to the plane of the opening of the brewing cup. This removal of the lid may be performed using a tool and/or a brew cup refilling apparatus. Next, one puts the particulate solid matter or other matter, as described above, into the cavity of the cup 200. This step may also be carried out using a tool and/or a brew cup refilling apparatus. The tool and/or the apparatus may engage the dovetail groove 150, ridges 170, and/or stepped notches 190 of the lid 100, in order to remove and/or reapply the lid to the cup 200. In an embodiment, a spring rod (not shown) may apply a constant force onto the top 105 of the lid 100 via the ridges 170, so that the lid is properly applied. The spring rod may be, for example, employed by a brew cup refilling machine.

The lid 100 is slid in place over the top, and liquid, typically hot liquid, enters between the depressed region 110 of the lid 100 having a top side 105, through the portal 120. The liquid is granted access to an inner cavity of the cup 200. The liquid may exit through lower portals and/or nozzles (not shown) of the cup 100. The liquid may then be dispensed and/or collected into a vessel or some other receptacle for liquids for consumption by the user. Typically, the cup 200 is fitted with a screen or filter, such that liquid may flow through and out of the cup, while the particulate solid matter is retained within the cup. After brewing, the lid 100 may be removed in a manner similar to the way it was applied, and the particulate solid matter in the cup 200 may be disposed of.

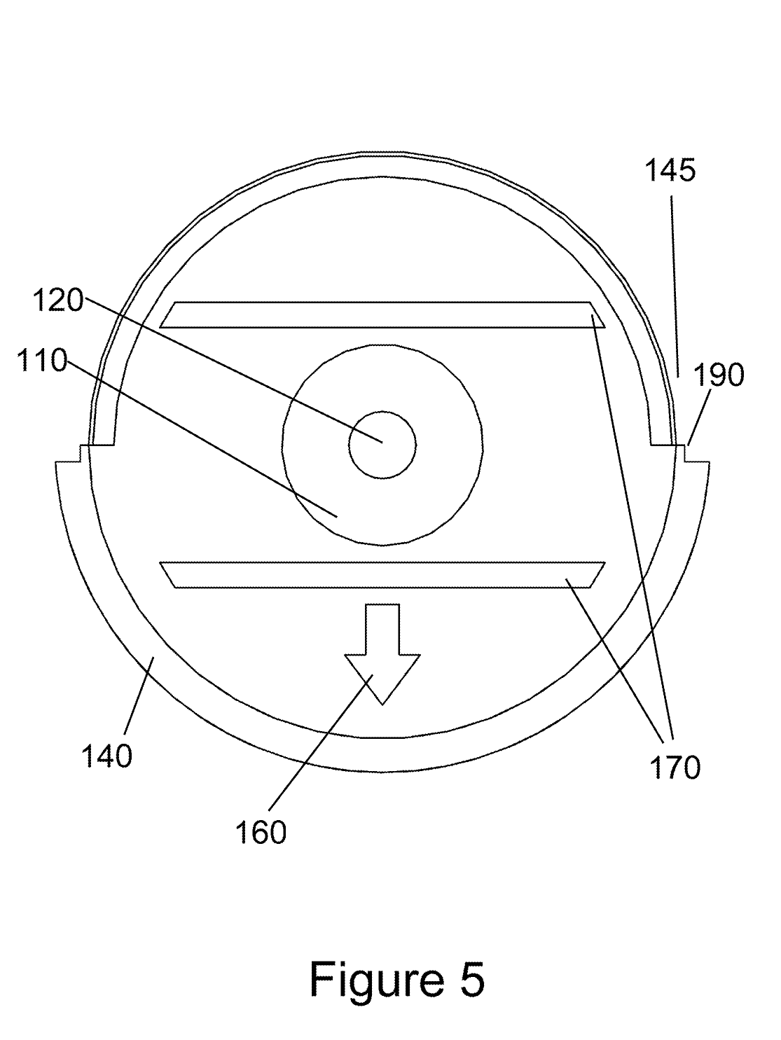

FIG. 5 shows a top plan view of the lid 100 of FIGS. 1 and 2. Here, one can see the overhead arrangement of the lip 140 extending circumferentially around the lid 100. The ends of the lip 140 may have stepped notches 190 that correspond to similar opposing notches on the cup 200. The indicator arrow 160 points in a direction of the lip 140 to indicate to the user that the lid 100 should only be slid in that particular direction when removal is desired. The ridges 170, as explained, are for catching corresponding grooves on a lid removal tool and/or in a brewing cup-filling apparatus, such as the apparatus described in U.S. patent application to Dakis titled Apparatus and Method for Refilling a Brewing Cup filed Jun. 4, 2013, the contents of which are hereby incorporated by reference.

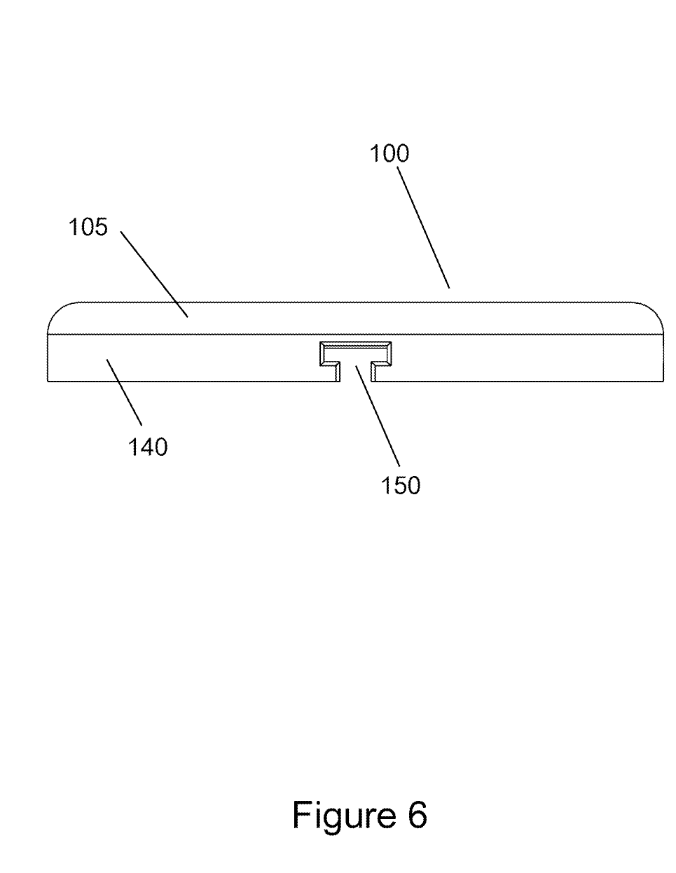

FIG. 6 shows a front elevation view of the lid 100 of FIGS. 1 and 2. Here, one can see the arrangement of the dovetail groove 150 in the lip 140. The dovetail groove 150 may be used in removing and/or re-applying the lid to the cup 200. Thus, a tool would be inserted into the dovetail groove 150, and pulled in the direction of the indicator arrow 160 (i.e., away from the lip 140 and/or groove 150).

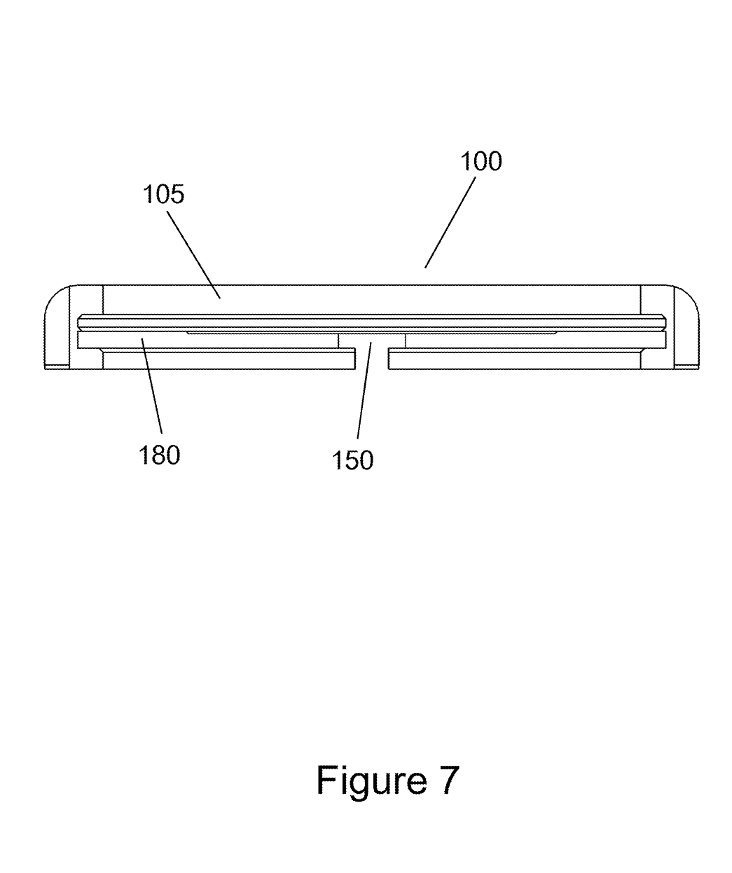

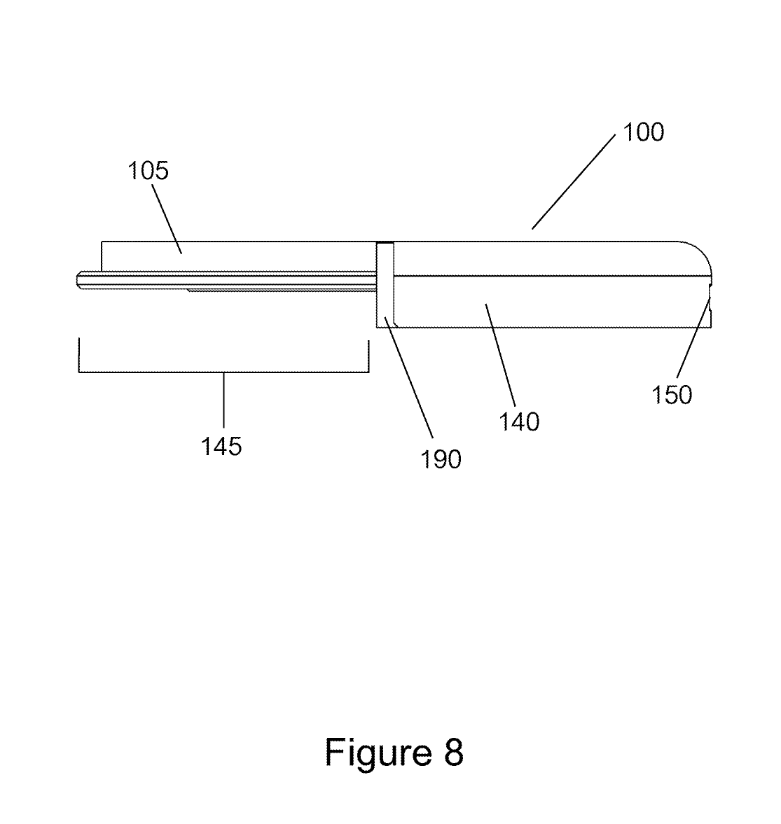

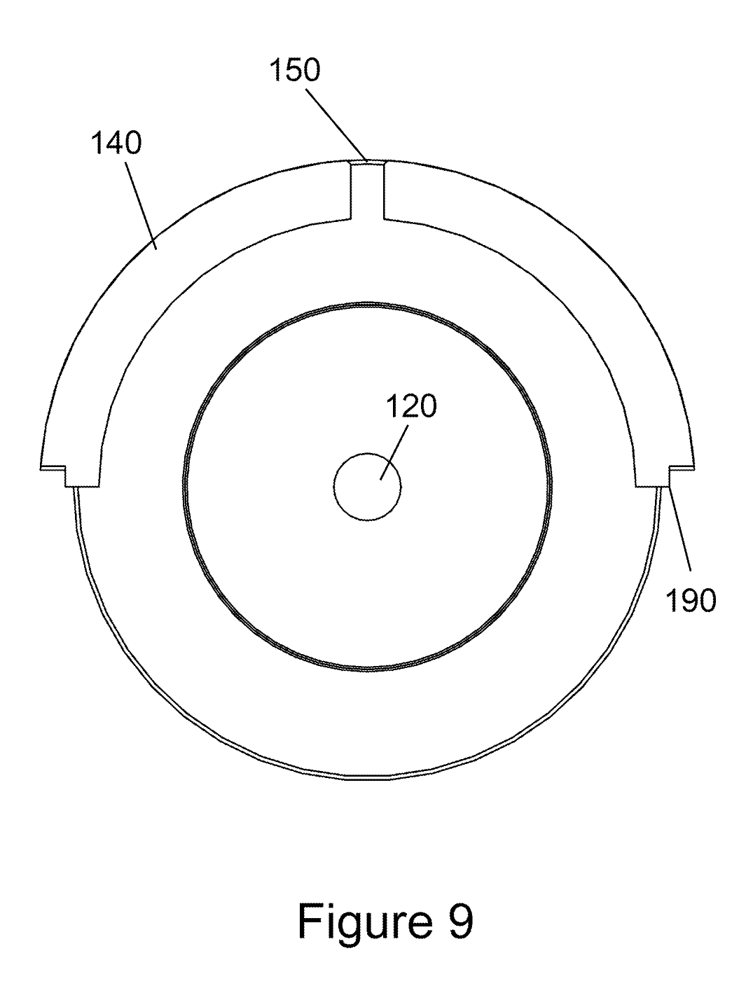

FIG. 7 shows a rear elevation view of the lid 100 of FIGS. 1 and 2. FIG. 8 shows a side elevation view of the lid 100 of FIGS. 1 and 2. FIG. 9 shows a bottom plan view of the lid 100 of FIGS. 1 and 2. As illustrated, the slot 180 is oriented such that the flange of the cup 200 fits into the slot upon the sliding of the lid 100 onto the cup 200.

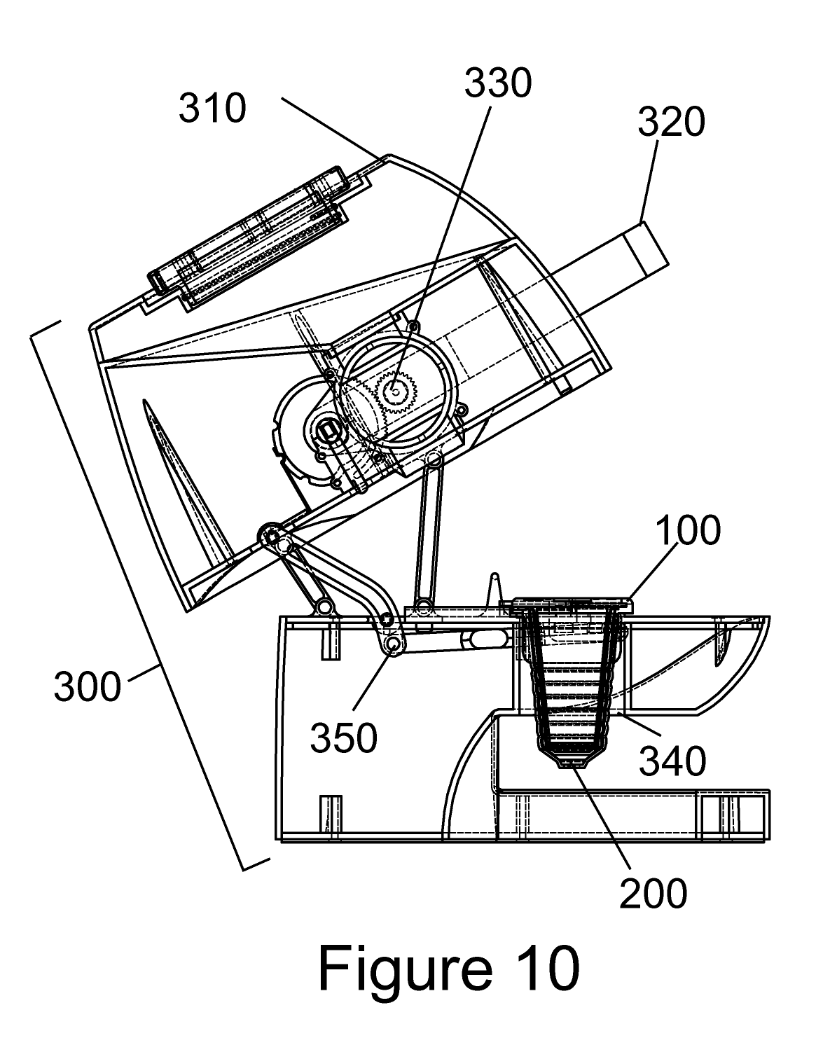

FIG. 10 shows a side schematic view of a combination lid and cup used in an automated brew cup refilling apparatus in an open position according to embodiments of the disclosed technology. The automated brew cup refilling apparatus (herein “apparatus”) may be any apparatus that performs the function of, and/or assists a user in, removing the lid 100 from the brew cup 200, filling the brew cup with particulate solid matter, reapplying the lid, and/or brewing the particulate solid matter enclosed in the brew cup. In the embodiment shown, the apparatus 300 generally may have a hopper 310, a lever 320, an inner valve 330, and/or a brew cup receptacle 340. Generally, for operation, the apparatus 300 is opened to expose the brew cup receptacle 340. An empty brew cup 200 with lid 100 is placed in the receptacle 340, and the apparatus 300 is closed. The lever 320 is rotated to cause the inner valve 330 to collect solid particulate matter from the hopper 310, and dispense the solid particulate matter into the brew cup 200.

The apparatus may have a mechanism for removing and/or re-applying the lid 100. The mechanism may be, for example, a removal arm 350 operable to remove the lid 100 when the apparatus 300 is closed. Referring still to FIG. 10, a removal arm 350 is shown cradling the stepped notches 190 of the lid 100. In this open position, the lid 100 remains on the brew cup 200. In other embodiments, a removal arm and/or any other tool, may alternatively use the dovetail groove 150 of the lid 100 for removal.

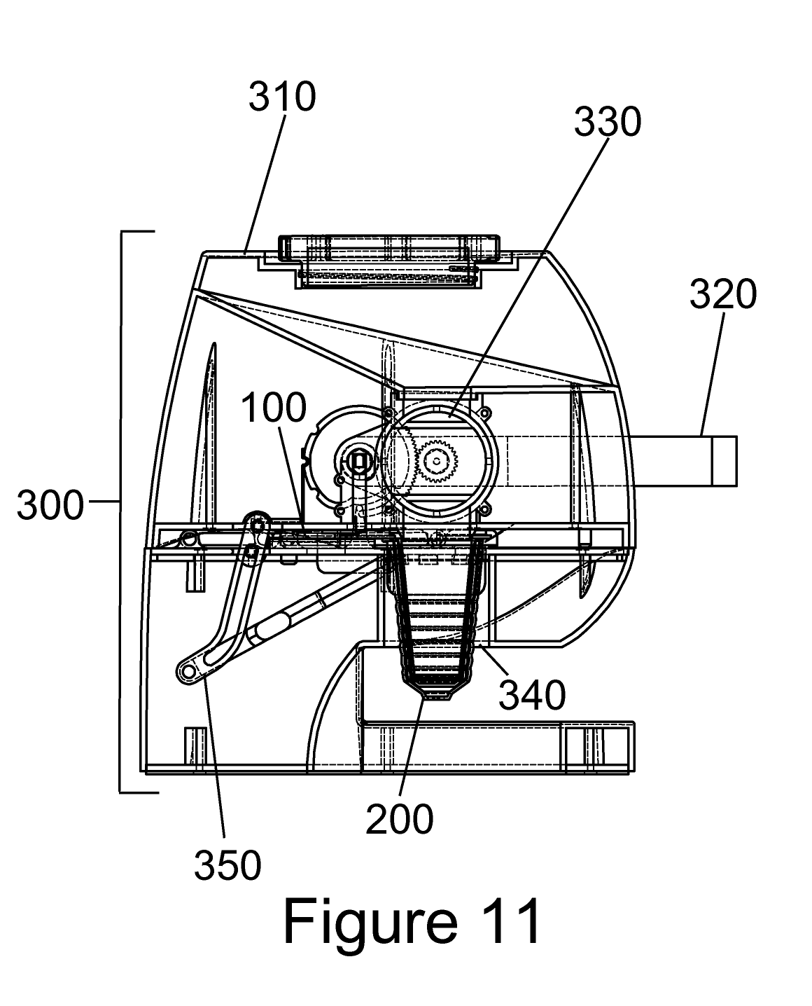

FIG. 11 shows the automated brew cup refilling apparatus of FIG. 10 in a closed/neutral position. As the apparatus 300 is closed, the removal arm 350 is caused to retract, thereby removing the lid 100 from the brew cup 200. The removal arm 350 pulls on the lid 100, using the stepped notches 190 of the lip 140. The removal of the lid 100 is performed in preparation for dispensing of the particulate solid matter into the brew cup 200. As the lever 320 is rotated, the inner valve 330 is caused to rotate. In FIG. 11, the lever 320 is shown in a neutral position. That is, the inner valve 330 is closed and is not collecting particulate solid matter from the hopper or dispensing particulate solid matter into the brew cup 200.

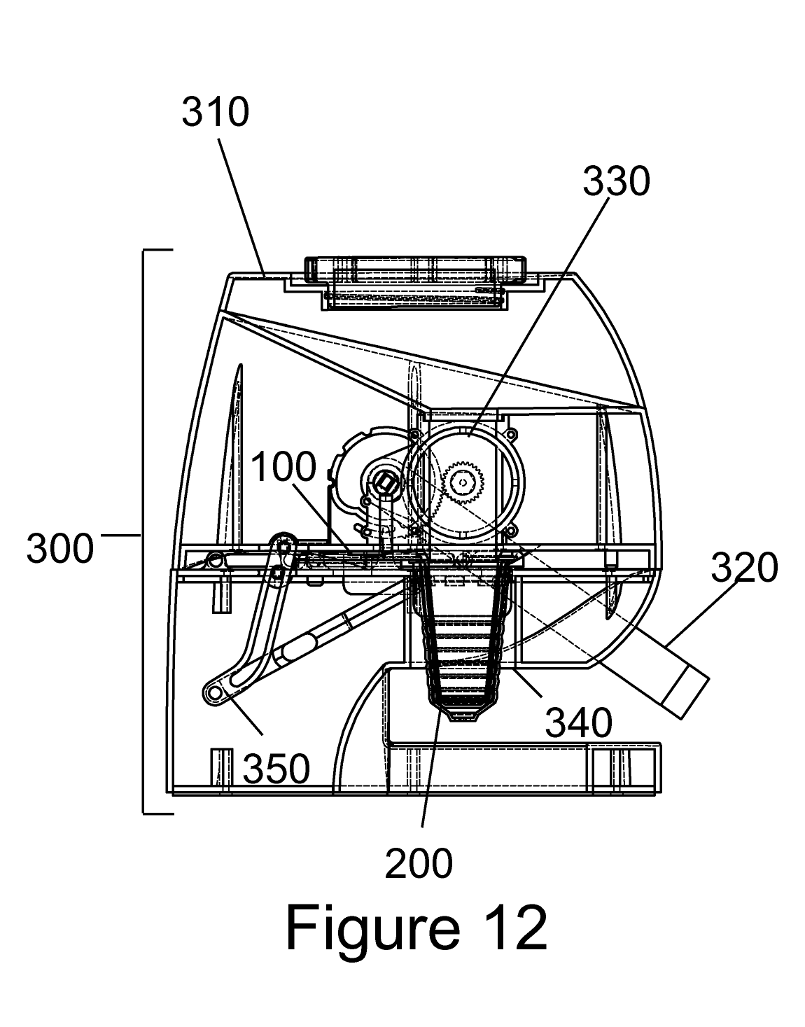

FIG. 12 shows the automated brew cup refilling apparatus of FIG. 10 in a dispensing position. In FIG. 12, any particulate solid matter residing in the inner valve 330 is dumped into the brew cup 200. In the position shown, the lid 100 is retained in close proximity to the brew cup 200, but is sufficiently far away from the opening of the brew cup, so as to allow particulate solid matter to be dispensed into the brew cup 200. After the brew cup 200 has been filled, the apparatus 300 may be reopened for retrieval of the reassembled lid 100 and brew cup 200. Upon opening of the apparatus 300, the removal arm 350 slides the lid 100 back onto the top of the brew cup 200. Thus, at no point should the user see, or be exposed to, the interior of the brew cup 200. Once filled, the brew cup 200 is ready for use in a single-cup brewing machine.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A lid for a brewing cup, comprising:
a generally flat, circular body having a lip extending partially around an outer circumference at a first geometric arc thereof, such that said circular body is bare around a remaining geometric arc, said lip on a side of said body adapted to engage said brewing cup and to form a slot between a bottom of said lip and a corresponding bottom side of said body;
a portal disposed through said body perpendicular to said outer circumference of said body;
said brewing cup having a flange around a circular opening, said flange having a geometric arc corresponding to said remaining geometric arc of said lid; and
wherein said flange of said brewing cup corresponds to said slot of said lid.

2. A method of applying said lid to said cup of claim 1, comprising inserting said flange of said cup into said slot of said lid.

3. The method of claim 2, wherein said lid is restricted to sliding along a single axis during application to said cup.

4. The lid of claim 1, wherein said lip of said lid and a lip of said cup form a continuous lip that circuitously runs a circumference of said cup and said lid.

5. The lid of claim 1, wherein said geometric arc of said flange is equal to said remaining geometric arc of said lid.

6. The lid of claim 1, wherein an inside of said slot of said lid is abutted on three sides by three corresponding sides of said flange of said cup.

7. The lid of claim 1, further comprising a groove disposed through the lip of the body, wherein said groove is used to remove said lid from said brewing cup.

8. The lid of claim 1, further comprising a depression around the portal, wherein said depression extends outward from a midpoint of an outer extent of a circular cross section of said body.

9. The lid of claim 1, wherein said lip extends around less than 51% of the outer circumference of the body.

10. The lid of claim 1, further comprising ridges disposed on a top surface of said body to aid in removal and/or re-application of said lid.

11. A combination cup and lid, said cup comprising an opening disposed for attachment of said lid;
said cup further comprising a bifurcated lip wherein substantially half of said bifurcated lip is wider than substantially another half of said bifurcated lip;
wherein said bifurcated lip inversely corresponds to bifurcated portions of a lip of said lid; and
wherein said lid is attachable and retainable onto said cup, such that said lid covers said cup in a closed position when said lid moves perpendicularly to a plane of the opening of said cup, such that said bifurcated portions of said lip of said lid align and merge with said bifurcations in said lip of said cup.

12. The combination cup and lid of claim 11, wherein said bifurcated portions of said lip of said lid and said bifurcated lip of said cup, when aligned and merged, give an appearance of a single, continuous lip that circuitously runs a circumference of said combination cup and said lid.

13. The combination cup and lid of claim 11, wherein said lid comprises a dovetail groove for removing and/or reapplying of said lid to said cup.

14. The combination cup and lid of claim 11, wherein said lid is slidable only along a single axis.

15. A method of using a lid on a brewing cup, said lid having a bifurcated lip extending partially around a circumference thereof, and said brewing cup having a bifurcated lip of equal but inverse proportions to said bifurcated lip of said lid, comprising steps of:
sliding said lid onto said brewing cup, wherein said sliding comprises moving said lid perpendicularly to the plane of an opening of said brewing cup; and
aligning and merging said bifurcated lip of said lid with said bifurcated lip of said brewing cup, such that said bifurcated lips collectively form a single, continuous lip circumferentially disposed about said opening of said brewing cup.

16. The method of claim 11, further comprising a step of removing said lid from said brewing cup by sliding said lid away from said brewing cup in a direction perpendicular to a plane of an opening of said brewing cup.

17. The method of claim 11, wherein said steps of said method are carried out by an automated brew cup refilling apparatus.

18. The method of claim 16, wherein said step of removing said lid is performed by a thumb of a user.

19. The method of claim 15, wherein said lid is slidable only along a single axis.

20. The method of claim 15, wherein a flange of said cup is mated to a slot of said lid.
